(19) United States
(12) Patent Application Publication
(10) Pub. No.: US 2024/0379112 A1
(43) Pub. Date: Nov. 14, 2024

(54) DETECTING SYNTHETIC SPEECH

(71) Applicant: SRI International, Menlo Park, CA (US)

(72) Inventors: MD Hafizur Rahman, Santa Clara, CA (US); Christopher L. Cobo-Kroenke, San Francisco, CA (US); Martin Graciarena, Belmont, CA (US)

(21) Appl. No.: 18/661,313

(22) Filed: May 10, 2024

Related U.S. Application Data
(60) Provisional application No. 63/465,740, filed on May 11, 2023.

(51) Int. Cl. G10L 17/26; G10L 17/02; G10L 17/04

(52) U.S. Cl. CPC G10L 17/26; G10L 17/02; G10L 17/04

(57) ABSTRACT

In general, the disclosure describes techniques for detecting synthetic speech in an audio clip. In an example, a computing system may include processing circuitry and memory for executing a machine learning system. The machine learning system may be configured to process an audio clip to generate a plurality of speech artifact embeddings based on a plurality of synthetic speech artifact features. The machine learning system may further be configured to compute one or more scores based on the plurality of speech artifact embeddings. The machine learning system may further be configured to determine, based on the one or more scores, whether one or more frames of the audio clip include synthetic speech. The machine learning system may further be configured to output an indication of whether the one or more frames of the audio clip include synthetic speech.

### RELATED APPLICATIONS

This application claims the benefit of U.S. Patent Application No. 63/465,740, filed May 11, 2023, which is incorporated by reference herein in its entirety.

### GOVERNMENT RIGHTS

This invention was made with government support under contract number HR001120C0124 awarded by DARPA. The government has certain rights in the invention.

### TECHNICAL FIELD

This disclosure relates to machine learning systems and, more specifically, to machine learning systems to detect synthetic speech.

### BACKGROUND

Deep fakes are increasingly becoming a concern of national interest that has fueled the rapid spread of fake news. Deep fakes often include audio of speech that may be manipulated with synthetic speech that emulates or clones a speaker of the original audio of speech. Synthetic speech may be generated by many different techniques for speech generation, such as applying various text to speech models. Synthetic speech may be included or injected in original audio of speech, meaning only portions of the audio of speech includes synthetic speech.

### SUMMARY

In general, the disclosure describes techniques for detecting synthetic speech in an audio clip. A system obtains an audio clip that includes speech from a speaker that may be original speech from the speaker and/or partially or wholly synthetic speech purporting to be from the speaker. The system may obtain the audio clip as audio data input by a user that wants to determine whether the audio data includes at least some synthetic speech injected in the audio data to manipulate speech of a speaker speaking. The system processes the obtained audio clip using a machine learning system trained to identify specific portions (e.g., frames) of audio clips that include synthetic speech. The machine learning system may generate speech artifact embeddings for the obtained audio clip based on synthetic speech artifact features extracted by the machine learning system. For example, the machine learning system may generate speech artifact embeddings based on the synthetic speech artifact features that indicate artifacts in synthetic speech left behind by various speech generators.

The machine learning system may compute scores for an obtained audio clip based on the generated speech artifact embeddings. The machine learning system may, for example, compute the scores by applying probabilistic linear discriminant analysis (PLDA) to compute scores for the obtained audio clip based on enrollment vectors associated with authentic speech and the speech artifact embeddings. The machine learning system may compute segment scores for frames of the obtained audio clip to determine whether one or more frames of the obtained audio clip include synthetic speech. In some instances, the machine learning system may additionally or alternatively compute an utterance level score representing a likelihood the whole waveform of the obtained audio includes synthetic speech.

The techniques may provide one or more technical advantages that realize at least one practical application. For example, the system may apply the machine learning system to detect synthetic speech in audio clips that may be interleaved with authentic speech. Conventionally, synthetic speech detection techniques focus on detecting fully synthetic audio recordings. The machine learning system, according to the techniques described herein, may be trained to identify synthetic speech based on synthetic speech artifact features left behind from various speech generation tools to avoid over-fitting detection of synthetic speech generated by any one speech generation tool. The machine learning system, according to the techniques described herein, may operate as a robust synthetic audio detector that can detect synthetic audio in both partially synthetic and fully synthetic audio waveforms. In this way, the system may indicate to a user whether an input audio clip has been modified, and which specific frames of the audio clip have been modified to include synthetic speech audio, if any.

In one example, a method includes processing, by a machine learning system, an audio clip to generate a plurality of speech artifact embeddings based on a plurality of synthetic speech artifact features. The method may further include computing, by the machine learning system, one or more scores based on the plurality of speech artifact embeddings. The method may further include determining, by the machine learning system, based on the one or more scores, whether one or more frames of the audio clip include synthetic speech. The method may further include outputting an indication of whether the one or more frames of the audio clip include synthetic speech.

In another example, a computing system may include processing circuitry and memory for executing a machine learning system. The machine learning system may be configured to process an audio clip to generate a plurality of speech artifact embeddings based on a plurality of synthetic speech artifact features. The machine learning system may further be configured to compute one or more scores based on the plurality of speech artifact embeddings. The machine learning system may further be configured to determine, based on the one or more scores, whether one or more frames of the audio clip include synthetic speech.

In another example, computer-readable storage media may include machine readable instructions for configuring processing circuitry to process, by a machine learning system, an audio clip to generate a plurality of speech artifact embeddings based on a plurality of synthetic speech artifact features. The processing circuitry may further be configured to compute one or more scores based on the plurality of speech artifact embeddings. The processing circuitry may further be configured to determine, by the machine learning system, based on the one or more scores, whether one or more frames of the audio clip include synthetic speech.

The details of one or more examples of the techniques of this disclosure are set forth in the accompanying drawings and the description below. Other features, objects, and advantages of the techniques will be apparent from the description and drawings, and from the claims.

### BRIEF DESCRIPTION OF DRAWINGS

FIG. 1 is a block diagram illustrating an example computing environment in which a computing system detects whether audio includes synthetic speech, in accordance with techniques of this disclosure.

FIG. 2 is a block diagram illustrating an example computing system with an example machine learning system trained to detect synthetic speech in audio clips, in accordance with techniques of this disclosure.

FIG. 3 is a conceptual diagram illustrating an example graphical user interface outputting example indications of frames of an audio clip including synthetic speech, in accordance with techniques of this disclosure.

FIG. 4 is a flowchart illustrating an example mode of operation for determining synthetic speech in an audio clip, in accordance with techniques of this disclosure.

Like reference characters refer to like elements throughout the figures and description.

### DETAILED DESCRIPTION

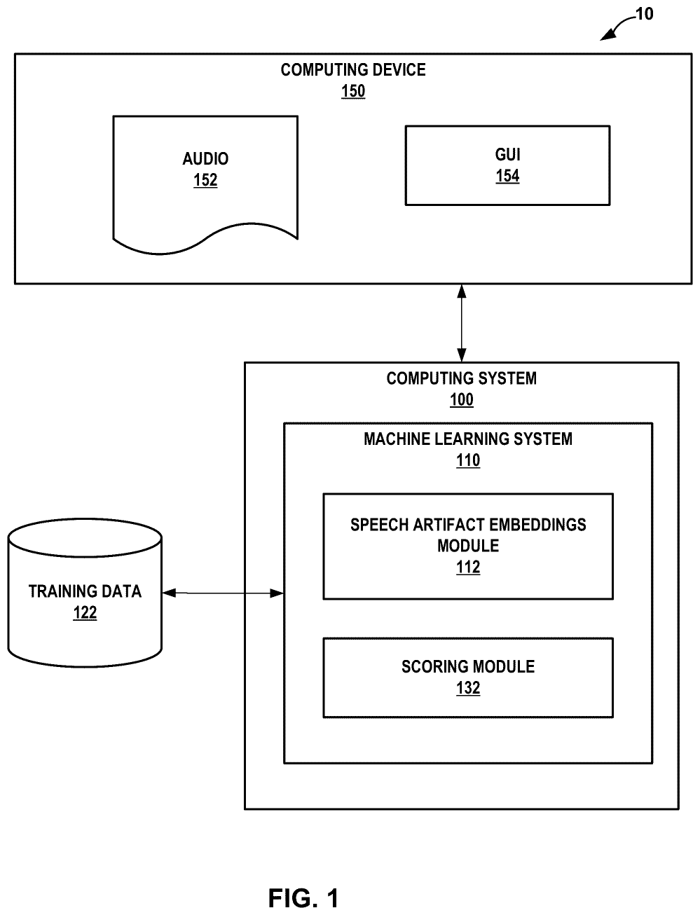

FIG. 1 is a block diagram illustrating example computing environment 10 in which computing system 100 detects whether audio 152 includes synthetic speech, in accordance with techniques of this disclosure. Computing environment 10 includes computing system 100 and computing device 150. Computing device 150 may be a mobile computing device, such as a mobile phone (including a smartphone), a laptop computer, a tablet computer, a wearable computing device, or any other computing device. In the example of FIG. 1, computing device 150 stores audio 152 and includes graphical user interface (GUI) 154. Audio 152 is audio data that includes one or more audio clips having audio waveforms representing speech from a speaker. Audio 152 may include original speech recorded from a speaker as well as synthetic speech in the speaker's voice, i.e., generated and purporting to be from the speaker. GUI 154 is a user interface that may be associated with functionality of computing device 150. For example, GUI 154 of FIG. 1 may be a user interface for a software application associated with detecting synthetic speech in audio clips, such as the frames of synthetic speech included in audio 152. Although illustrated in FIG. 1 as internal to computing device 150, GUI 154 may generate output for display on an external display device. In some examples, GUI 154 may provide an option for a user of computing device 150 to input audio 152 to detect whether audio 152 includes audio of synthetic speech. Although illustrated as external to computing system 100, computing device 150 may be a component of computing system 100. Although not shown, computing device 150 and computing system 100 may communicate via a communication channel, which may include a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks or communication channels for transmitting data between computing systems, servers, and computing devices. In addition, although not shown, computing system 100 may receive audio 152 from a storage device that interfaces with computing system 100 and that stores audio 152. Such storage devices may include a USB drive, a disk drive (e.g., solid state drive or hard drive), an optical disc, or other storage device or media.

Computing system 100 may represent one or more computing devices configured to execute machine learning system 110. Machine learning system 110 may be trained to detect synthetic speech in audio (e.g., audio 152). In the example of FIG. 1, machine learning system 110 includes speech artifact embeddings module 112 and scoring module 132.

In accordance with techniques described herein, computing system 100 may output a determination of whether audio 152 includes at least one frame of synthetic speech. Audio 152, for example, may include an audio file (e.g., waveform audio file format (WAV), MPEG-4 Part 14 (MP4), etc.) with audio of speech that may be partially or wholly synthetic. Audio 152 may be audio that is associated with video or other multimedia. As used herein, an audio clip refers to any audio stored to media. Computing system 100 may obtain audio 152 from computing device 150 via a network, for example.

Computing system 100, applying speech artifact embeddings module 112 of machine learning system 110, may generate a plurality of speech artifact embeddings for corresponding frames of audio 152. Speech artifact embeddings module 112 may generate the speech artifact embeddings as vector representations of synthetic speech artifact features of frames of audio 152 in a high-dimensional space. Speech artifact embeddings module 112 may include one or more machine learning models (e.g., Residual Neural Networks (ResNets), other neural networks such as recurrent neural networks (RNNs) or deep neural networks (DNNs), etc.) trained with training data 122 to generate speech artifact embeddings for frames of audio clips based on synthetic speech artifact features. Synthetic speech artifact features may include acoustic features of artifacts in synthetic speech of a frame in an audio clip that have been left behind by various speech generators. Speech artifact embeddings module 112 may apply acoustic feature extraction techniques to identify and extract synthetic speech artifact features of audio 152. For example, speech artifact embeddings module 112 may be trained to apply acoustic feature extraction techniques (e.g., Linear Filter Bank, Mel-Frequency Cepstral Coefficients, Power-Normalized Cepstral Coefficients, Constant Q Cepstral Coefficients, etc.) to extract synthetic speech artifact features from many different speech generators as vectors that may specify waveform artifacts in frequency regions outside the fixed spectral range of human speech. Speech artifact embeddings module 112 may extract synthetic speech artifact features from audio 152 for a predefined window of frames (e.g., 20 milliseconds). Speech artifact embeddings module 112 may include a timestamp in vectors of the synthetic speech artifact features specifying a time frame of audio 152 (e.g., 20 milliseconds to 40 milliseconds of audio included in audio 152) corresponding to extracted speech artifact features.

Speech artifact embeddings module 112 may be trained to extract synthetic speech artifact features based on training data 122. Training data 122 is stored to a storage device and includes training audio clips with one or more frames of audio including synthetic speech generated by various speech generators. In some instances, prior to or at the same time as extracting synthetic speech artifact features from training audio clips of training data 122, speech artifact embeddings module 112 may apply a machine learning model (e.g., a deep neural network) to remove non-speech information (e.g., silences, background noise, etc.) from the training audio clips of training data 122. Speech artifact embeddings module 112 may determine non-speech information from training audio clips of training data 122 and remove vectors of synthetic speech artifact features corresponding to time frames of the determined non-speech information. Speech artifact embeddings module 112 may apply the machine learning model (e.g., a speech activity detector) to identify non-speech information in audio 152 and remove, based on timestamps included in vectors of the synthetic speech artifact features, synthetic speech artifact features associated with audio 152 that correspond to the identified non-speech instances. In this way, speech artifact embeddings module 112 may effectively extract synthetic speech artifact features that do not consider non-speech information that may overwhelm critical information that synthetic speech artifact features are based upon.

Speech artifact embeddings module 112 may process synthetic speech artifact features associated with audio 152 using the one or more machine learning models to generate speech artifact embeddings for frames of audio 152 that capture distortions or frequency artifacts associated with audio waveforms in frames of audio 152 that may have been generated by a speech generator. Speech artifact embeddings module 112 may include a timestamp of a frame in a speech artifact embedding generated for the frame. Speech artifact embeddings module 112 may generate the speech artifact embeddings based on synthetic speech artifact features by training an embeddings or latent space of the one or more machine learning models of speech artifact embeddings module 112 with synthetic speech artifact features extracted from synthetic speech clips of training data 122. In some examples, speech artifact embeddings module 112 may train the one or more machine learning models to generate speech artifact embeddings based on audio clips by mapping speech artifact features (e.g., synthetic speech artifact features and/or authentic speech artifact features) to an embedding space of the one or more machine learning models. Speech artifact embeddings module 112 may determine boundaries in the mapping of the speech artifact features based on labels of speech clips included in training data 122 identifying whether audio waveform frames corresponding to the speech artifact features include synthetic speech. Speech artifact embeddings module 112 may apply the boundaries during training of the one or more machine learning models to improve generalization of synthetic speech artifact features represented in speech artifact embeddings across unknown conditions.

Computing system 100 may generate speech artifact embeddings as vector representations of distortions included in audio 152 that may have been created by one or more speech generators of various types. Speech artifact embeddings module 112 may train the one or more machine learning models to generate speech artifact embeddings based in part on training data 122. In some instances, speech artifact embeddings module 112 may augment training audio clips included in training data 122 to improve generalizations made about audio clips, avoid the one or more machine learning models over fitting to any one speech generator, and/or defeat anti-forensic techniques that may be implemented by synthetic speech generators. For example, by speech artifact embeddings module 112 augmenting training audio clips of training data 122, machine learning system 210 may be trained to be more robust as to overcome deliberate augmentations to synthetic speech that may be implemented by synthetic speech generators. Speech artifact embeddings module 112 may augment training audio clips of training data 122 using one or more data augmentation strategies. For example, speech artifact embeddings module 112 may augment training audio clips of training data 122 by injecting different types of audio degradation (e.g., reverb, compression, instrumental music, noise, etc.) to the training audio clips. In some examples, speech artifact embeddings module 112 may augment training audio clips of training data 122 by applying frequency masking techniques. Speech artifact embeddings module 112 may apply frequency masking techniques to training audio clips of training data 122 to randomly dropout frequency bands during training of the one or more machine learning models of speech artifact embeddings module 112.

Scoring module 132 of machine learning system 110 may generate one or more scores based on the speech artifact embeddings generated by speech artifact embeddings module 112. Scoring module 132 may apply probabilistic linear discriminant analysis (PLDA) to the speech artifact embeddings to generate probabilities (e.g., log-likelihood ratios) for each speech artifact embedding that corresponds to a likelihood a frame associated with the speech artifact embedding includes synthetic speech. For example, scoring module 132 may determine a probability that a frame corresponding to a speech artifact embedding includes synthetic speech by comparing the speech artifact embedding to an enrollment embedding associated with authentic speech. Scoring module 132 may determine the probabilities based on enrollment embeddings that may include a vector representation of authentic speech artifact features from authentic speech in audio clips (e.g., training speech clips of training data 122). Enrollment embeddings may include a vector representation of authentic speech artifact features such as pitch, intonation, rhythm, articulation, accent, pronunciation pattern, or other human vocal characteristics. In some instances, scoring module 132 may apply a machine learning model (e.g., residual networks, neural networks, etc.) to generate enrollment embeddings based on training speech clips of training data 122 that include authentic speech.

Scoring module 132 may convert each of the probabilities for each speech artifact embedding to segment scores for corresponding frames that represent whether the corresponding frames include synthetic speech. Scoring module 132 may label segment scores with corresponding timestamps associated with frames that corresponding speech artifact embeddings represent. Scoring module 132 may determine whether one or more frames of an audio clip include synthetic speech based on the segment scores. For example, scoring module 132 may determine a frame of audio 152 includes synthetic speech based on a segment score associated with the frame satisfying a threshold (e.g., a segment score greater than zero). Additionally, or alternatively, scoring module 132 may determine a frame of audio 152 does not include synthetic speech, and is authentic, based on a segment score associated with the frame satisfying a threshold (e.g., a segment score less than 0.2). Scoring module 132 may determine specific time frames of audio 152 where synthetic speech was detected based on timestamps corresponding to the segment score. Computing system 100 may output an indication of the determination of which frames, if any, of audio 152 include synthetic speech to computing device 150. The indication may include specific references to the time frames in which synthetic speech was detected. Computing device 150 may output the indication via GUI 154.

In some instances, scoring module 132 may generate an utterance level score for the whole waveform of an audio clip (e.g., audio 152) based on the segment scores for each from of the audio clip. For example, scoring module 132 may generate an utterance level score for an audio clip by averaging all segment scores. Computing system 100 may output the segment scores and utterance level scores to computing device 150. Computing device 150 may output the segment scores and utterance level score via GUI 154 to allow a user to identify whether one or more frames of audio 152 include synthetic speech.

The techniques may provide one or more technical advantages that realize at least one practical application. For example, machine learning system 110 may determine whether only a portion or the entirety of an audio clip includes synthetic speech. Speech artifact embeddings module 112 of machine learning system 110, in generating speech artifact embeddings for frames or sets of frames of audio 152, allows machine learning system 110 to determine specific temporal locations of synthetic speech that may have been injected in audio 152. Machine learning system 110 may train one or more machine learning models of speech artifact embeddings module 112 to generate speech artifact embeddings based on synthetic speech artifact features to ultimately detect synthetic speech generated by many different speech generators. By augmenting and refining the training data used in the training of the one or more machine learning models, machine learning system 110 may avoid overfitting the one or more machine learning models to specific speech generators. Machine learning system 110 may train the one or more machine learning models for robust synthetic speech detection of synthetic speech generated by any number or variety of speech generators.

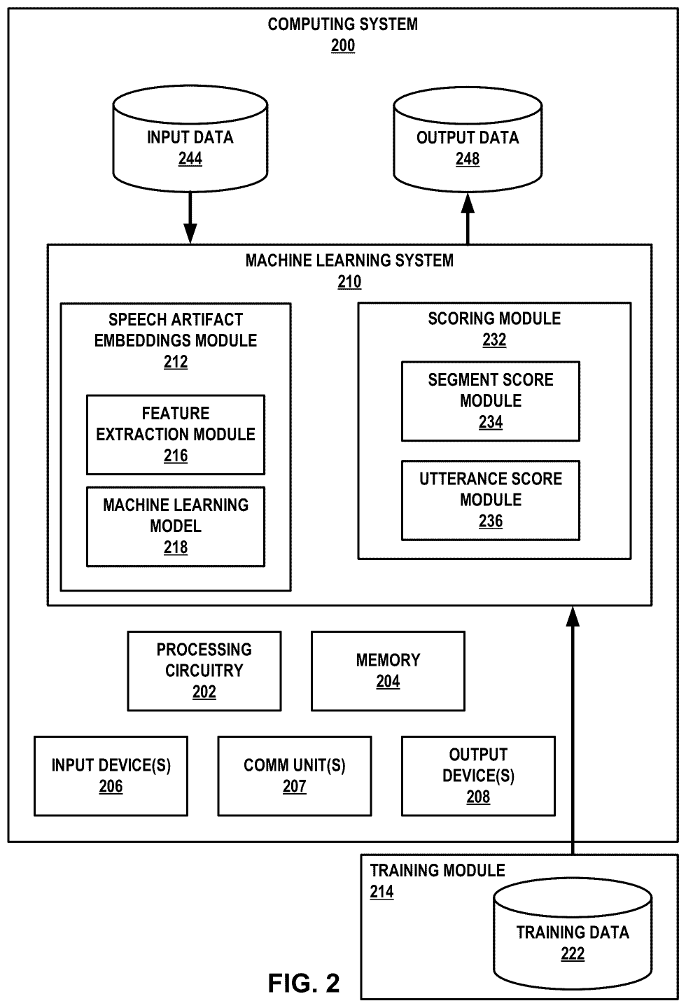

FIG. 2 is a block diagram illustrating example computing system 200 with example machine learning system 210 trained to detect synthetic speech in audio clips, in accordance with techniques of this disclosure. Computing system 200, machine learning system 210, speech artifact embeddings module 212, training data 222, and scoring module 232 of FIG. 2 may be example or alternative implementations of computing system 100, machine learning system 110, speech artifact embeddings module 112, training data 122, and scoring module 132 of FIG. 1, respectively.

Computing system 200 comprises any suitable computing system having one or more computing devices, such as servers, desktop computers, laptop computers, gaming consoles, smart televisions, handheld devices, tablets, mobile telephones, smartphones, etc. In some examples, at least a portion of computing system 200 is distributed across a cloud computing system, a data center, or across a network, such as the Internet, another public or private communications network, for instance, broadband, cellular, Wi-Fi, ZigBee, Bluetooth® (or other personal area network-PAN), Near-Field Communication (NFC), ultrawideband, satellite, enterprise, service provider and/or other types of communication networks, for transmitting data between computing systems, servers, and computing devices.

Computing system 200, in the example of FIG. 2, may include processing circuitry 202, one or more input devices 206, one or more communication units (“COMM” units) 207, and one or more output devices 208 having access to memory 204. One or more input devices 206 of computing system 200 may generate, receive, or process input. Such input may include input from a keyboard, pointing device, voice responsive system, video camera, biometric detection or response system, button, sensor, mobile device, control pad, microphone, presence-sensitive screen, network, or any other type of device for detecting input from a human or machine.

One or more output devices 208 may generate, transmit, or process output. Examples of output are tactile, audio, visual, and/or video output. Output devices 208 may include a display, sound card, video graphics adapter card, speaker, presence-sensitive screen, one or more USB interfaces, video and/or audio output interfaces, or any other type of device capable of generating tactile, audio, video, or other output. Output devices 208 may include a display device, which may function as an output device using technologies including liquid crystal displays (LCD), quantum dot display, dot matrix displays, light emitting diode (LED) displays, organic light-emitting diode (OLED) displays, cathode ray tube (CRT) displays, e-ink, or monochrome, color, or any other type of display capable of generating tactile, audio, and/or visual output. In some examples, computing system 200 may include a presence-sensitive display that may serve as a user interface device that operates both as one or more input devices 206 and one or more output devices 208.

One or more communication units 207 of computing system 200 may communicate with devices external to computing system 200 (or among separate computing devices of computing system 200) by transmitting and/or receiving data, and may operate, in some respects, as both an input device and an output device. In some examples, communication units 207 may communicate with other devices over a network. In other examples, communication units 207 may send and/or receive radio signals on a radio network such as a cellular radio network. Examples of communication units 207 may include a network interface card (e.g., such as an Ethernet card), an optical transceiver, a radio frequency transceiver, a GPS receiver, or any other type of device that can send and/or receive information. Other examples of communication units 207 may include Bluetooth®, GPS, 3G, 4G, and Wi-Fi® radios found in mobile devices as well as Universal Serial Bus (USB) controllers and the like.

Processing circuitry 202 and memory 204 may be configured to execute machine learning system 210 to determine whether an input audio clip includes synthetic speech, according to techniques of this disclosure. Memory 204 may store information for processing during operation of speech artifact embeddings module 212 and scoring module 232. In some examples, memory 204 may include temporary memories, meaning that a primary purpose of the one or more storage devices is not long-term storage. Memory 204 may be configured for short-term storage of information as volatile memory and therefore not retain stored contents if deactivated. Examples of volatile memories include random access memories (RAM), dynamic random access memories (DRAM), static random access memories (SRAM), and other forms of volatile memories known in the art. Memory 204, in some examples, also include one or more computer-readable storage media. Memory 204 may be configured to store larger amounts of information than volatile memory. Memory 204 may further be configured for long-term storage of information as non-volatile memory space and retain information after activate/off cycles. Examples of non-volatile memories include magnetic hard disks, optical discs, floppy disks, Flash memories, or forms of electrically programmable memories (EPROM) or electrically erasable and programmable (EEPROM) memories. Memory 204 may store program instructions and/or data associated with one or more of the modules (e.g., speech artifact embeddings module 212 and scoring module 232 of machine learning system 210) described in accordance with one or more aspects of this disclosure.

Processing circuitry 202 and memory 204 may provide an operating environment or platform for speech artifact embeddings module 212 and scoring module 232, which may be implemented as software, but may in some examples include any combination of hardware, firmware, and software. Processing circuitry 202 may execute instructions and memory 204 may store instructions and/or data of one or more modules. The combination of processing circuitry 202 and memory 204 may retrieve, store, and/or execute the instructions and/or data of one or more applications, modules, or software. Processing circuitry 202 and memory 204 may also be operably coupled to one or more other software and/or hardware components, including, but not limited to, one or more of the components illustrated in FIG. 2. Processing circuitry 202, input devices 206, communication units 207, output devices 208, and memory 204 may each be distributed over one or more computing devices.

In the example of FIG. 2, machine learning system 210 may include speech artifact embeddings module 212 and scoring module 232. Speech artifact embeddings module 212 may include feature extraction module 216 and machine learning model 218. Feature extraction module 216, may include a software module with computer-readable instructions for extracting synthetic speech artifact features. Machine learning model 218 may include a software module with computer-readable instructions for a machine learning model (e.g., a residual neural network) trained to generate speech artifact embeddings based on synthetic speech artifact features determined by feature extraction module 216.

In accordance with techniques described herein, machine learning system 210 may detect whether one or more frames of an audio clip include synthetic speech. Machine learning system 210 may obtain input data 244 that includes an audio clip (e.g., audio 152 of FIG. 1) that may include one or more frames of synthetic speech audio. In some instances, machine learning system 210 may obtain input data 244 from a user device (e.g., computing device 150 of FIG. 1) via a network or wired connection. In some examples, input data 244 may be directly uploaded to computing system 200 by an administrator of computing system 200 via input devices 206 and/or communication units 207. For example, input data 244 may include an audio clip, downloaded from the Internet (e.g., from a social media platform, from a streaming platform, etc.), that a user operating computing system 200 believes may be manipulated with synthetic speech audio generated by a synthetic speech generator.

Machine learning system 210 may process the audio clip included in input data 244 using speech artifact embeddings module 212. Feature extraction module 216 of speech artifact embeddings module 212 may extract synthetic speech artifact features from the audio clip. For example, feature extraction module 216 may apply a filter bank (e.g., Linear Filter Bank, Mel-Frequency Cepstral Coefficients, Power-Normalized Cepstral Coefficients, Constant Q Cepstral Coefficients, etc.) to extract distortions and/or degradations of speech audio included in the audio clip according to a predefined frame rate (e.g., extracting distortions and/or degradations for time windows or frames capturing 20 to 30 millisecond portions of an audio waveform included in an audio clip). Feature extraction module 216 may encode synthetic speech artifact features of speech audio for each frame of the audio clip (e.g., a frame or time window of audio corresponding to a segment of an audio waveform included in the 20 millisecond to 30 millisecond portion of the audio clip) as vector representations of distortions or degradations identified in corresponding frames. Feature extraction module 216 may include a timestamp in each synthetic speech artifact feature vector specifying a corresponding frame (e.g., an indication included in metadata of a synthetic speech artifact feature vector that the represented synthetic speech artifact features were extracted from the 20 millisecond to 30 millisecond frame of the audio clip).

Training module 214, in the example of FIG. 2, may be stored at a storage device external to computing system 200 (e.g., a separate training computing system). In some examples, training module 214 may be stored at computing system 200. Training module 214 may include a software module with computer-readable instructions for training feature extraction module 216 and machine learning model 218.

Training module 214 may train feature extraction module 216 to extract synthetic speech artifact features. Training module 214 may train feature extraction module 216 based on training speech clips in training data 222. For example, training module 214 may train feature extraction module 216 with training speech clips stored at training data 222 that include training audio clips with partially or wholly synthetic speech generated by various synthetic speech generators. Training module 214 may train a filter bank (e.g., Linear Filter Bank, Mel-Frequency Cepstral Coefficients, Power-Normalized Cepstral Coefficients, Constant Q Cepstral Coefficients, etc.) of feature extraction module 216 to extract synthetic speech artifacts (e.g., frequency regions outside the fixed spectral range of human speech) with high spectral resolution over a predefined time window. For example, training module 214 may train feature extraction module 216 to apply 70 triangular linearly spaced filters to extract synthetic speech artifact features from audio clips with a 25 millisecond window and a 10 millisecond frameshift.

Feature extraction module 216 may refine the synthetic speech artifact features by removing synthetic speech artifact features that may correspond to frames where there is no speech. Feature extraction module 216 may include a speech activity detector with a machine learning model (e.g., a deep neural network) trained to identify pauses, silences, background noise, or other non-speech information included in an audio clip. Feature extraction module 216 may apply the speech activity detector to identify non-speech information in the audio clip included in input data 244. Feature extraction module 216 may apply the speech activity detector to identify non-speech information over the same time window as the filter bank of feature extraction module 216 extracted synthetic speech artifact features. The speech activity detector of feature extraction module 216 may output a Boolean value for each frame of the audio clip included in input data 244 (e.g., audio corresponding to waveforms included in the 20 millisecond to 30 millisecond frame of the audio clip) specifying whether non-speech information was detected (e.g., output a value of 1 if a pause or silence is detected or output a value of 0 if speech is detected). The speech activity detector may include a timestamp in each output specifying a corresponding frame (e.g., an indication output with the Boolean value that speech or silence was detected from the 20 millisecond to 30 millisecond frame of the audio clip). Feature extraction module 216 may remove or prune synthetic speech artifact features generated by the filter bank based on outputs of the speech activity detector identifying frames of the audio clip with non-speech information. Feature extraction module 216 may provide machine learning model 218 the synthetic speech artifact features associated with the audio clip included in input data 244.

Training module 214 may train machine learning model 218 to generate speech artifact embeddings. Training module 214 may train machine learning model 218 based on training speech clips included in training data 222. In some instances, training module 214 may train machine learning model 218 with augmented training speech clips of training data 222 with various data augmentation strategies. For example, training module 214 may augment training speech clips of training data 222 with different types of audio degradation (e.g., reverb, compression, instrumental music, noise, etc.). Training module 214 may additionally, or alternatively, augment training speech clips of training data 222 by applying frequency masking to randomly dropout frequency bands from the training speech clips. Training module 214 may augment training speech clips of training data 222 to avoid poor deep-learning model performance and model over fitting.

In some examples, training module 214 is implemented by a separate training computing system that trains machine learning model 218 as described above. In such examples, trained machine learning model 218 is exported to computing system 200 for use in detecting synthetic speech.

Machine learning model 218 may generate speech artifact embeddings based on synthetic speech artifact features. Machine learning model 218 may include a machine learning model, such as a deep neural network with an X-ResNet architecture, trained to generate speech artifact embeddings that capture relevant information of artifacts, distortions, degradations, or the like from synthetic speech artifact features extracted from feature extraction module 216. Machine learning model 218 may include a deep neural network with an X-ResNet architecture that utilizes more discriminant information from input features. For example, machine learning model 218 may be a deep neural network including a residual network architecture with a modified input stem including 3×3 convolutional layers with stride 2 in the first layer for down sampling, with 32 filters in the first two layers, and 64 filters in the last layer. Machine learning model 218 may provide the modified input stem the synthetic speech artifact features with a height dimension of 500 corresponding to a temporal dimension (e.g., frames of the audio clip included in input audio 244), a width dimension of 70 corresponding to a filter bank index, and a depth dimension of 1 corresponding to image channels. Machine learning model 218 may include one or more residual blocks of the residual network that serially down clip inputs from the modified input stem or previous residual blocks, and doubles the number of filters to keep the computation constant. Machine learning model 218 may include residual blocks that down clip inputs with 2×2 average pooling for anti-aliasing benefits and/or a 1×1 convolution to increase the number of feature maps that match a residual path's output. In some instances, machine learning model 218 may include Squeeze-and-Excitation (SE) blocks to adaptively re-calibrate convolution channel inter-dependencies into a global feature such that the dominant channels can achieve higher weights. Machine learning model 218 may implement SE blocks throughout the residual network (e.g., after processing by the modified input stem and before the first residual block). Machine learning model 218 may provide the final output of the residual blocks or stages of the residual network to a statistical pooling and embeddings layer of the residual network for further processing. Machine learning model 218 may extract embeddings from the last layer of the residual network as speech artifact embeddings.

During training of machine learning model 218, training module 214 may train machine learning model 218 to output speech artifact embeddings. For example, training module 214 may apply a one-class feature learning approach to train a compact embeddings space of the residual network of machine learning model 218 by introducing margins to consolidate target authentic speech and isolate synthetic speech data. Training module 214 train the embeddings space of the residual network of machine learning model 218 according to the following function:

$${L}_{OC} = \frac{1}{N} {\sum }_{i = 1}^{N} log ( 1 + {e}^{α ( {m}_{{y}_{i}} - {\hat{w}}_{0} {\hat{x}}_{i} ) {( - 1 )}^{{y}_{i}}} )$$

where xᵢ ∈ [symbol] ^{D} represents the normalized target-class, ŵ₀ ∈ [symbol] ^{D} represents the weight vector, yᵢ ∈ 0, 1 denotes clip labels (e.g., 0 for synthetic and 1 for authentic), and m₀, m₁ ∈ [−1,1], where m₀>m₁ are the angular margins between classes. Training module 214 may apply the function to train the embeddings space of the residual network of machine learning model 218 to establish one or more boundaries in the embeddings space corresponding to whether an extracted synthetic speech artifact feature should be included in a speech artifact embedding. For example, training module 214 may provide extracted synthetic speech artifact features from training speech clips of training data 222 to machine learning model 218. Machine learning model 218 may apply a machine learning model (e.g., a residual network) to process the input synthetic speech artifact features. Machine learning model 218 may map the processed synthetic speech artifact features to an embeddings space of the residual network. Training module 214 may apply the function to the processed synthetic speech artifact features to determine one or more boundaries in the mapping of the processed synthetic speech artifact features to the embeddings space that outline an area in the embeddings space mapping where processed synthetic speech artifact features correspond to either synthetic or authentic speech based on labels of the training speech clip associated with the processed synthetic speech artifact features. In this way, the residual network of machine learning model 218 may be trained with improved deep neural network generalization across unknown conditions. Machine learning model 218 may apply the boundaries during inference time to determine which of the processed synthetic speech artifact features should be represented in speech artifact embeddings. For example, during inference time, machine learning model 218 may map processed synthetic speech artifact features associated with a frame of an input audio clip to the embeddings space and generate a speech artifact embedding to include a vector representation of the processed synthetic speech artifact features that were mapped within the area of the embeddings space corresponding to synthetic speech.

During the inference phase of machine learning system 210 determining whether an audio clip of input data 244 includes at least one frame of synthetic speech, speech artifact embeddings module 212 may provide the speech artifact embeddings generated by machine learning model 218 to scoring module 232. Scoring module 232 may include a probabilistic linear discriminant analysis (PLDA) back-end classifier. Scoring module 232 may leverage the PLDA classifier to provide better generalization across real-world data conditions. For example, in instances where interleaved audio is detected, scoring module 232 may apply the PLDA classifier for highly accurate interleaved aware score processing based on window-score smoothing.

Scoring module 232 may compute one or more scores for frames of the audio clip included in input data 244 based on the speech artifact embeddings. For example, scoring module 232 may apply PLDA to compute scores based on speech artifact embeddings and enrollment embeddings that represent speech artifact features associated with authentic speech. Scoring module 232 may reduce dimensions of speech artifact embeddings generated by speech artifact embeddings module 212 with a linear discriminant analysis (LDA) transformation and gaussianization of the input speech artifact embeddings. For example, scoring module 232 may process speech artifact embeddings according to the following equation:

$${w}_{i} = μ + {U}_{1} \cdot {x}_{1} + {ϵ}_{i}$$

where wᵢ represents the transformed speech artifact embeddings, μ represents the mean vector, U₁ represents the eigen matrix, x₁ represents the hidden factor, and ∈ᵢ represents the residual variability. Scoring module 232 may provide the transformed speech artifact embeddings to segment score module 234.

Segment score module 234 may compute segment scores for each frame of the audio clip included in input data 244 based on the speech artifact embeddings. For example, segment score module 234 may determine a segment score as a likelihood synthetic speech was injected in a frame of the audio clip by comparing speech artifact embeddings transformed using LDA to enrollment vectors. Scoring module 232 may provide segment score module 234 enrollment embeddings that include vectors representing speech artifact features of authentic speech. Enrollment embeddings may include vectors representing features of authentic speech based on clips of authentic speech included in training data 222. Scoring module 232 may obtain enrollment embeddings from an administrator operating computing system 200 or may generate enrollment embeddings with a machine learning model trained to embed speech artifact features similar to speech artifact embeddings module 212. Segment score module 234 may compute a segment score (e.g., log-likelihood ratio, value between 0-1, etc.) for a frame of the audio clip included in input data 244 by comparing a corresponding speech artifact embedding (e.g., a corresponding transformed speech artifact embedding) to the enrollment vectors using PLDA. Segment score module 234 may determine temporal locations (e.g., frames) of the audio clip with synthetic speech based on the segment scores for each frame of the audio clip. For example, segment score module 234 may determine the 20 millisecond to 30 millisecond frame of the audio clip includes synthetic speech based on a corresponding segment score satisfying a threshold (e.g., the corresponding segment score is greater than 0.0). Segment score module 234 may output indications of the temporal locations that include synthetic speech as output data 248.

In some instances, utterance score module 236 may compute an utterance level score representing whether the whole waveform of an audio clip includes synthetic speech. Utterance score module 236 may determine an utterance level score for an audio clip based on segment scores. Utterance score module 236 may obtain the segment scores from segment score module 234. Utterance score module 236 may determine an utterance level score by averaging all segment scores determined by segment score module 234. In some examples, utterance score module 236 may apply simple interleaved aware score post-processing based on window-score smoothing to determine an utterance level score. For example, utterance score module 236 may smooth the segment scores output by segment score module 234 with a multiple window mean filter of ten frames. Utterance score module 234 may average the score of the top 5% smoothed window scores to determine the utterance score for an entire waveform of the audio clip included in input data 244. Utterance score module 234 may determine whether the entire waveform of an input audio clip includes synthetic speech based on the utterance score. Utterance score module 234 may output an indication of whether the entire waveform of the input audio clip includes synthetic speech as output data 248.

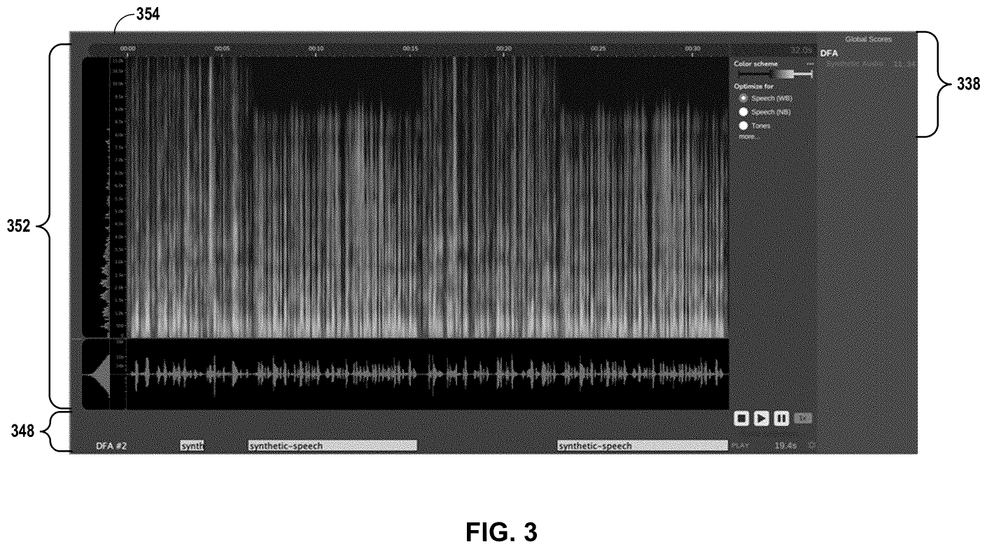

FIG. 3 is a conceptual diagram illustrating example graphical user interface 354 outputting example indications of frames 348 of audio clip 352 including synthetic speech, in accordance with techniques of this disclosure. FIG. 3 may be discussed with respect to FIG. 1 and FIG. 2 for example purposes only.

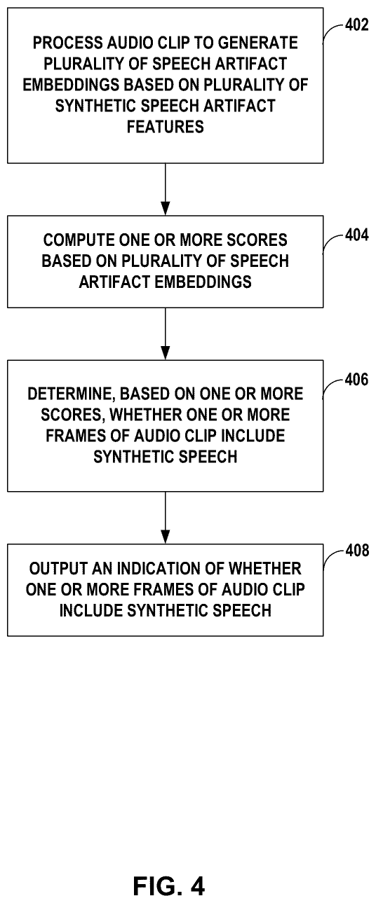

In some instances, computing system 100 may output data for generating graphical user interface 354 to computing device 150. That is, graphical user interface 354 of FIG. 4 may be an example or alternative implementation of GUI 154 of FIG. 1. In some examples, computing system 200 may output graphical user interface 354 via output devices 208. Regardless of where graphical user interface 354 is output, computing system 100 and/or computing system 200 may generate data for outputting graphical user interface 354 based on scores calculated by scoring module 132 and/or scoring module 232, respectively. For example, scoring module 232, or more specifically segment score module 234, may calculate scores for each frame of audio clip 352 based at least on speech artifact embeddings generated by speech artifact embeddings module 212, as previously discussed. Scoring module 232, in the example of FIG. 3, may determine that scores calculated for multiple frames satisfy a threshold, thereby indicating the multiple frames include synthetic speech. Scoring module 232 may generate, based on the calculated scores, data for graphical user interface 354 including indication of frames 348 that identify the multiple frames or portions of audio clip 352 that include synthetic speech.

Additionally, or alternatively, scoring module 232, or more specifically utterance score module 236, may calculate an utterance level score or global score for audio clip 352. Utterance score module 236 may calculate the global score based on segment scores calculated for frames of audio clip 352. Utterance score module 236 may output the global score as global score 338. In the example of FIG. 3, utterance score module 236 may generate data for graphical user interface 354 including global score 338 that identifies a score of 11.34.

FIG. 4 is a flowchart illustrating an example mode of operation for determining synthetic speech in an audio clip, in accordance with techniques of this disclosure. FIG. 4 may be discussed with respect to FIG. 1 and FIG. 2 for example purposes only.

Computing system 200 may process an audio clip to generate a plurality of speech artifact embeddings based on a plurality of synthetic speech artifact features (402). For example, computing system 200 may obtain audio 152 from a user device (e.g., computing device 150) or from a user operating computing system 200. Computing system 200 may generate, with machine learning system 210, a plurality of speech artifact embeddings for audio 152 based on a plurality of synthetic speech artifact features. For example, feature speech artifact embeddings module 212 of machine learning system 210 may process audio 152 to extract the plurality of synthetic speech artifact features from audio 152 that represent potential artifacts, distortions, degradations, or the like that have been left behind by a variety of synthetic speech generators. Machine learning model 218 of speech artifact embeddings module 212 may generate the plurality of speech artifact embeddings by processing the extracted synthetic speech artifact features to identify processed synthetic speech artifact features that correspond to relevant information of synthetic speech generation (e.g., processed synthetic speech artifact features that are within a boundary defined as features left behind by various synthetic speech generators).

Computing system 200 may compute one or more scores based on the plurality of speech artifact embeddings (404). For example, scoring module 232, or more specifically segment score module 234, may obtain the speech artifact embeddings from machine learning model 218 to generate a segment score for each speech artifact embedding by comparing a speech artifact embedding to an enrollment embedding representing speech artifact features of authentic speech. Segment score module 234 may apply PLDA to generate segment scores as a log-likelihood ratio a frame of input audio 152 includes synthetic speech. Scoring module 232, or more specifically utterance score module 236, may additionally, or alternatively, generate an utterance level score representing whether the waveform of audio 152, as a whole, includes synthetic speech generated by various synthetic speech generators. Utterance score module 236 may, for example, generate an utterance level score for audio 152 applying a simple interleaved aware score post-processing based on window-score smoothing to segment scores generated by segment score module 234.

Computing system 200 may determine, based on one or more scores, whether one or more frames of the audio clip include synthetic speech (406). Scoring module 232 may determine whether a frame of audio 152 includes synthetic speech based on a segment score generated by segment score module 234 satisfying a threshold. For example, scoring module 232 may determine a frame (e.g., the 20 millisecond to 30 millisecond frame of audio 152) includes synthetic speech based on a corresponding segment score satisfying (e.g., greater than or less than) a threshold segment score of 0.0. Scoring module 232 may output an indication of whether the one or more frames include synthetic speech (408). For example, scoring module 232 may output an indication as either a probability or Boolean value (e.g., “Yes” or “No”) associated with whether one or more frames of audio 152 include synthetic speech. Scoring module 232 may include, as part of the indication, particular time frames of audio 152 associated with the synthetic speech. Scoring module 232 may output the indication as output data 248. In some examples, scoring module 232 may output the indication via output devices 208.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit comprising hardware may also perform one or more of the techniques of this disclosure.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components or integrated within common or separate hardware or software components.

The techniques described in this disclosure may also be embodied or encoded in computer-readable media, such as a computer-readable storage medium, containing instructions. Instructions embedded or encoded in one or more computer-readable storage mediums may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

What is claimed is:

1. A method for detecting synthetic speech in frames of an audio clip, comprising:
processing, by a machine learning system, an audio clip to generate a plurality of speech artifact embeddings based on a plurality of synthetic speech artifact features;
computing, by the machine learning system, one or more scores based on the plurality of speech artifact embeddings;
determining, by the machine learning system, based on the one or more scores, whether one or more frames of the audio clip include synthetic speech; and
outputting an indication of whether the one or more frames of the audio clip include synthetic speech.

2. The method of claim 1, further comprising:
extracting the plurality of synthetic speech artifact features from frames of the audio clip, wherein the synthetic speech artifact features include at least one of artifacts, distortions, or degradations that are associated with one or more synthetic speech generators and that are included in the audio clip.

3. The method of claim 1, further comprising training a machine learning model of the machine learning system by at least:
providing the machine learning model with training data including a plurality of training audio clips;
extracting a plurality of training synthetic speech artifact features from the plurality of training audio clips, wherein one or more frames of each training audio clip of the plurality of training audio clips includes synthetic speech audio generated by at least one synthetic speech generator of a plurality of synthetic speech generators;
mapping the plurality of training synthetic speech artifact features to an embeddings space of the machine learning model; and
determining one or more boundaries in the mapping of the plurality of training synthetic speech artifact features based on labels included in the training data that identify whether frames associated with training synthetic speech artifact features of the plurality of training synthetic speech artifact features include synthetic speech audio.

4. The method of claim 3, further comprising:
modifying one or more training audio clips of the plurality of training audio clips included in the training data by at least one of: adding audio degradation to the one or more training audio clips or masking frequency bands of the one or more training audio clips.

5. The method of claim 1, further comprising:
obtaining the audio clip, wherein the audio clip is associated with a multimedia content item;
determining non-speech information included in the audio clip based on an audio waveform of the audio clip, and
removing, based on timestamps included in the non-speech information, synthetic speech artifact features associated with the non-speech information from the plurality of synthetic speech artifact features.

6. The method of claim 1, wherein computing the one or more scores comprises computing one or more log-likelihood ratios by at least comparing the plurality of speech artifact embeddings to a plurality of enrollment embeddings, wherein each of the plurality of enrollment embeddings are associated with authentic speech.

7. The method of claim 1,
wherein each speech artifact embedding of the plurality of speech artifact embeddings corresponds to a different frame of the audio clip, and
wherein the one or more scores includes a segment score for each of the plurality of speech artifact embeddings, each segment score representing a likelihood a corresponding frame of the audio clip includes synthetic speech.

8. The method of claim 1, wherein the one or more scores includes an utterance level score representing a likelihood the audio clip includes synthetic speech.

9. The method of claim 1, wherein outputting the indication comprises: responsive to determining a score of the one or more scores satisfies a threshold, outputting an indication that a frame of the one or more frames that corresponds to the score includes synthetic speech.

10. A computing system comprising processing circuitry and memory for executing a machine learning system, the machine learning system configured to:
process an audio clip to generate a plurality of speech artifact embeddings based on a plurality of synthetic speech artifact features;
compute one or more scores based on the plurality of speech artifact embeddings;
determine, based on the one or more scores, whether one or more frames of the audio clip include synthetic speech.

11. The computing system of claim 10, wherein the machine learning system is further configured to extract the plurality of synthetic speech artifact features from frames of the audio clip, wherein the synthetic speech artifact features include at least one of artifacts, distortions, or degradations that are associated with one or more synthetic speech generators and that are included in the audio clip.

12. The computing system of claim 10, wherein the machine learning system is further configured to:
provide a machine learning model of the machine learning system with training data including a plurality of training audio clips;
extract a plurality of training synthetic speech artifact features from the plurality of training audio clips, wherein one or more frames of each training audio clip of the plurality of training audio clips includes synthetic speech audio generated by at least one synthetic speech generator of a plurality of synthetic speech generators;
map the plurality of training synthetic speech artifact features to an embeddings space of the machine learning model; and
determine one or more boundaries in the mapping of the plurality of training synthetic speech artifact features based on labels included in the training data that identify whether frames associated with training synthetic speech artifact features of the plurality of training synthetic speech artifact features include synthetic speech audio.

13. The computing system of claim 10, wherein the machine learning system is further configured to:
obtain the audio clip, wherein the audio clip is associated with a multimedia content item;
determine non-speech information included in the audio clip based on an audio waveform of the audio clip, and
remove, based on timestamps included in the non-speech information, synthetic speech artifact features associated with the non-speech information from the plurality of synthetic speech artifact features.

14. The computing system of claim 10, wherein to compute the one or more scores, the machine learning system is configured to: compute one or more log-likelihood ratios by at least comparing the plurality of speech artifact embeddings to a plurality of enrollment embeddings, wherein each of the plurality of enrollment embeddings are associated with authentic speech.

15. The computing system of claim 10, wherein each speech artifact embedding of the plurality of speech artifact embeddings corresponds to a different frame of the audio clip, and
wherein the one or more scores includes a segment score for each of the plurality of speech artifact embeddings, each segment score representing a likelihood a corresponding frame of the audio clip includes synthetic speech.

16. The computing system of claim 10, wherein the one or more scores includes an utterance level score representing a likelihood the audio clip includes synthetic speech.

17. The computing system of claim 10, wherein the machine learning system is further configured to: responsive to determining a score of the one or more scores satisfies a threshold, output an indication that a frame of the one or more frames that corresponds to the score includes synthetic speech.

18. Computer-readable storage media comprising machine readable instructions for configuring processing circuitry to:
process, by a machine learning system, an audio clip to generate a plurality of speech artifact embeddings based on a plurality of synthetic speech artifact features;
compute, by the machine learning system, one or more scores based on the plurality of speech artifact embeddings; and
determine, by the machine learning system, based on the one or more scores, whether one or more frames of the audio clip include synthetic speech.

19. The computer-readable storage media of claim 18, wherein the machine readable instructions further configure the processing circuitry to: extract the plurality of synthetic speech artifact features from frames of the audio clip, wherein the synthetic speech artifact features include at least one of artifacts, distortions, or degradations that are associated with one or more synthetic speech generators and that are included in the audio clip.

20. The computer-readable storage media of claim 18, wherein the machine readable instructions further configure the processing circuitry to: responsive to determining a score of the one or more scores satisfies a threshold, output an indication that a frame of the one or more frames that corresponds to the score includes synthetic speech.
